(19) United States
(12) Patent Application Publication
(10) Pub. No.: US 2003/0088594 A1
(43) Pub. Date: May 8, 2003

(54) Method of constraining file systems in peer to peer networks

(76) Inventor: Youssef Hamadi, Bristol (GB)

Correspondence Address: HEWLETT-PACKARD COMPANY, Intellectual Property Administration, P. O. Box 272400, Fort Collins, CO, 80527-2400, US

(21) Appl. No.: 10/269,359

(22) Filed: Oct. 11, 2002

(30) Foreign Application Priority Data
Oct. 13, 2001 (GB) 0124629.7

(51) Int. Cl. G06F 12/00; G06F 17/30

(52) U.S. Cl. 707/205

(57) ABSTRACT

A method of constraining file systems of computers within a network comprising a plurality of peer to peer connected computers, said method comprising: selecting first and second computers of said plurality of computers; applying at least one constraint between respective file systems of said first and second computers.

### FIELD OF THE INVENTION

The present invention relates to networks of computers and particularly, although not exclusively to a method of constraining file systems in a network of computer entities.

### BACKGROUND TO THE INVENTION

Historically, networked computers have been organized according to a client-server architecture as is known in the art. The client-server architecture originates from the 1960s, at which time large, expensive mainframe computers had processing capacity and data storage capacity which was below the processing capacity and data storage capacity which can be found in a modern personal computer (PC). Mainframe computers were designated as servers, serving a number of client terminals, which referred to the server to obtain data, for example, stored in a database at the server. The client-server architecture persists in modern computer networks.

A known application of a client-server architecture is for file sharing. For example, the known Napster system relies on a client-server relationship.

Referring to FIG. 1 herein, there is illustrated schematically a logical representation of the known Napster client-server system, in which a plurality of client computers 100-102 communicate with a server 103 over the internet 104. Each client computer contains a hard disk drive and a processor, and is capable of storing MP3 music files on its local hard disk drive. The server computer 103, operated by Napster Corporation allows internet users to download MP3 audio files from other internet users. The Napster server 103 provides an address to a first client computer 100, of a second client computer 101 at which a particular MP3 music file can be found. Client-server architecture operates as follows. Individuals computers 100, 101, 102 each send a list of their locally stored MP3 files to the server 103. A client computer, for example a first computer 100, looking for a particular music file interrogates the database on the server 103. The server 103 responds with the location of a requested MP3 file, giving the URL of another client computer, which stores that file. Then first computer 100 makes a direct connection over the internet with the second client computer 101, which contains the desired MP3 file, and downloads that file directly from the second client computer 101. The server 103 acts to serve file location data to each of the client computers.

In more recent years, as the processing power and data storage capacity of computers has increased, an alternative architecture, known as peer to peer architecture has evolved, in which a plurality of networked computers communicate with each other over a local area network or wide area network. In a peer to peer arrangement, computers are treated logically as equals, and there is no hierarchical structure. In the general peer to peer case any computer within the network can serve information to any other computer, and any computer within a network can obtain data or processing resources from any other computer in the network, and subject to configurations applied by applications programs. An example of a well known peer to peer network is the file sharing system in Microsoft Windows 95, where files may be stored on individual personal computers, and accessed over a local area network by other computers within the network.

Referring to FIG. 2 herein, there is illustrated schematically a logical arrangement of a known peer to peer computer network comprising a plurality of personal computers 200-203, where each personal computer is treated as logically equivalent to each other computer in the network, and each computer in the network is connected to each other computer in the network by a local area network or wide area network. There is no requirement for a centralized server to centrally store data, or centrally provide processing power. Each computer in the network supplies its own processing power, and has its own local data storage device. In the arrangement of FIG. 2, as an example, first computer 200 may act as a client for second computer 201, but may also act as a server for third computer 202.

Modern computer entities are well suited to peer to peer networking, since modern computers provide enough processing power and data storage capacity at low cost, to act as client and/or server within a network.

In the general peer to peer case the topology of the network is unknown by any one computer in the network. In a large peer to peer network, there may be hundreds of computers, each capable of communicating with other computers in the network on an equal basis, with each computer capable of acting as a server for any other computer, or as a client of any other computer.

In the field of peer to peer computer networks, there is a known protocol known as the Gnutella system. The Gnutella system appeared as public information early in the year 2000, and is freely available on the internet, as will be known to those skilled in the art. The Gnutella protocol is a de facto standard for peer to peer computer networks, and comprises a set of rules which code the co-operation between peer computers, and which defines the way in which peer computers interact with each other for file transfer.

Referring to FIG. 3 herein, there is illustrated schematically a simple example of file sharing in a Gnutella network. In the example of FIG. 3 a network of peer to peer connected computer entities are represented as a set of nodes C1-C5, interconnected by a set of links L1-L6. For example, the network may comprise a plurality of personal home computers, interconnected by the internet. When the Gnutella network is switched on, a set of connections are created between computers within the network, according to the gnutella protocol. Suppose first computer C1 is to find a file music.MP3 from other second to fifth computers C2-C5 on the network. First computer C1 has connections only to computers C2, C3, C4, and stores the addresses of those computers only. It has no “knowledge” of fifth computer C5, and to reach fifth computer C5, needs the assistance of second computer C2. In a Gnutella system, C1 broadcasts a file request message to second to fourth computers C2-C4, these being the computers for which first computer C1 stores addresses locally. Second computer C2, propagates the request to other computers of which it is aware, including fifth computer C5.

In the known Gnutella network, when a file is requested, a user types in the name of file at their local computer, and then the computer sends a request for that file to a plurality of computers connected according to the Gnutella protocol. Each connected computer responds with a positive or negative message, depending upon whether that computer has the particular file requested. Computers which are not directly connected to the computer originating the file request, may receive the file request via an intermediate computer, and respond to the originating computer via the originating computer.

The computer which has the file music.MP3, in this case fifth computer C5, replies to computer C2, which then replies to computer C1. Similarly, fourth computer C4 replies directly to C1, third computer C3 replies directly to C1, and second computer C2 replies to C1, with a message that those computers do not store the file themselves. The reply message from fifth computer C5 is relayed back to first computer C1 via second computer C2.

In known Gnutella networks, a facility for automatic file sharing is not provided. The Gnutella protocol is designed for peer to peer file sharing, in which individual users search for files, and then decide to download those files. This system is useful where host computers and files to share are not necessarily known by any one computer.

However, in many applications, host computers are known to each other and particular files are known between host computers in a limited environment, for example within a company. In scenarios where a network is well defined automated file sharing is useful. However, the known Gnutella network does not provide any facility for automated file sharing.

Automated file sharing is otherwise known in the prior art in local networks, by using a synchronizing feature of known operating systems. However, automated file sharing is previously not available in wide area networks or virtual networks.

### SUMMARY OF THE INVENTION

According to a first aspect of the present invention there is provided a method of connecting file systems of computers within a network comprising a plurality of peer to peer connected computers, said method comprising the steps of:

selecting first and second computers of said plurality of computers;

applying at least one constraint between respective file systems of said first and second computers.

According to a second aspect of the present invention there is provided a computer entity comprising:

at least one data processor;

at least one memory device;

at least one data storage device;

a topology database storing topology data describing a set of constraints applied in a peer to peer network;

a file system, for storing data files within said data storage device;

a constraint database storing data describing a set of constraints applied to said computer entity between said computer entity and at least one other computer entity.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a prior art hierarchical client-server architecture in a known computer network;

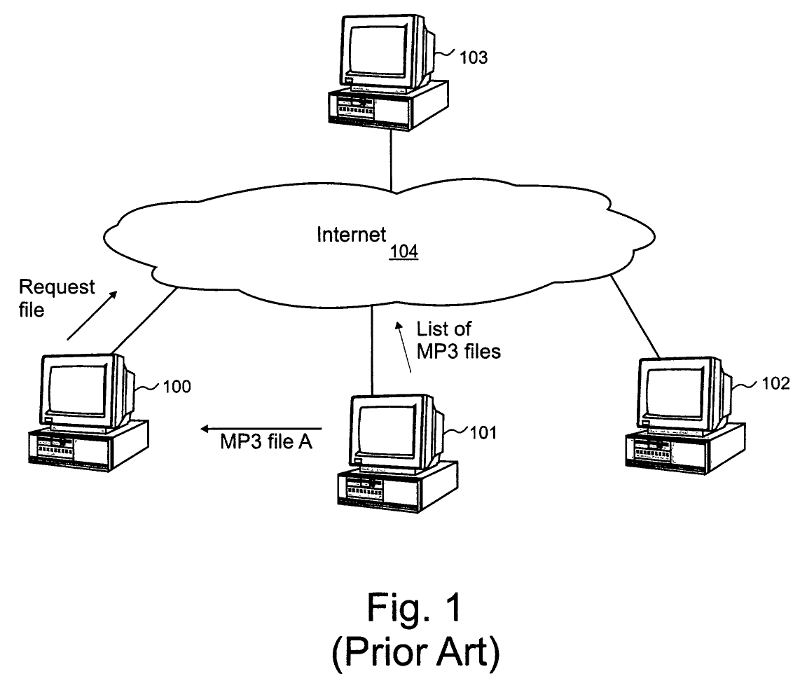

FIG. 2 illustrates schematically in logical view a known peer to peer architecture for a network of computers;

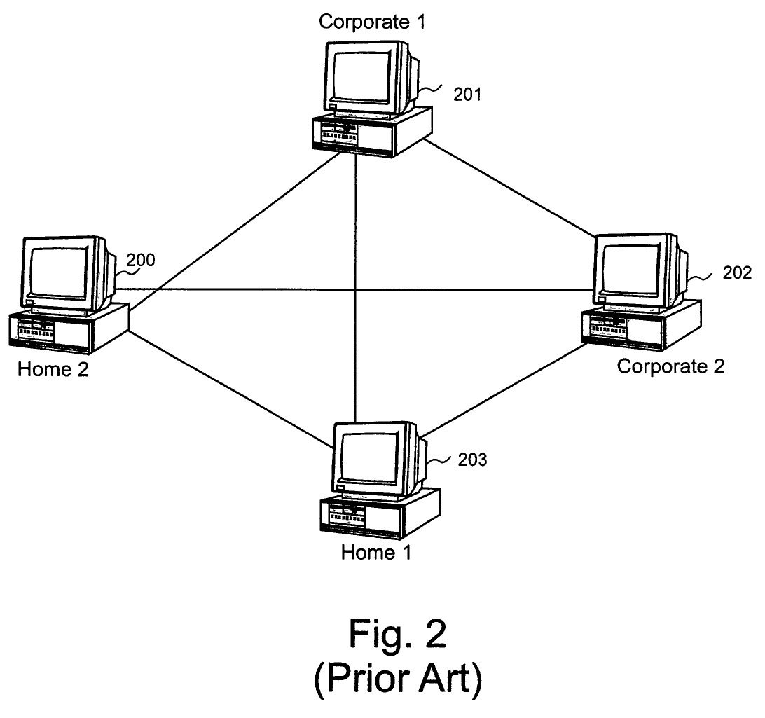

FIG. 3 illustrates schematically a simple example of file sharing in a peer to peer network operating according to a known Gnutella protocol;

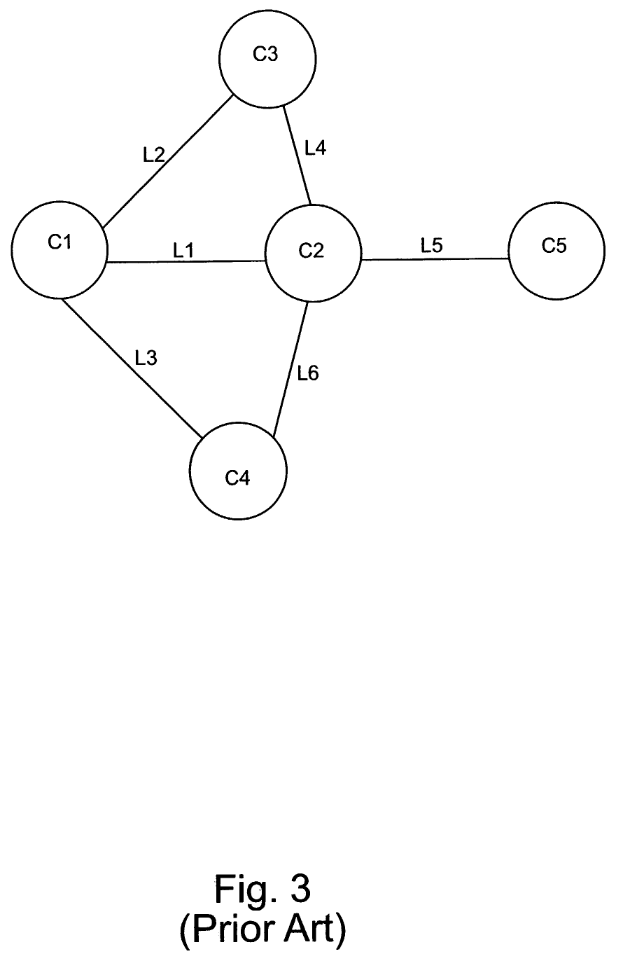

FIG. 4 illustrates schematically a file sharing operation in a peer to peer network according to a first specific implementation of the present invention;

FIG. 5 illustrates schematically use of constraints in the first specific implementation of FIG. 4;

FIG. 6 illustrates schematically a second example of a specific implementation of the present invention, in which a peer to peer network has applied a constraint overlay, in order to modify the file sharing behavior of the peer to peer computer network;

FIG. 7 illustrates schematically an equality constraint class according to a specific implementation of the present invention;

FIG. 8 illustrates schematically an inclusion constraint class, comprising the specific implementation of the present invention;

FIG. 9 illustrates schematically a difference constraint class comprising the specific implementation of the present invention;

FIG. 10 illustrates schematically an example of a constraint conflict which may occur in networks constructed according to a specific method of the present invention;

FIG. 11 illustrates schematically architecture and components of a computer entity for use in a constrained peer to peer network according to a first specific embodiment of the present invention;

FIG. 12 illustrates schematically logical components of the computer of FIG. 11;

FIG. 13 illustrates schematically components of a file sharing module comprising the computer of FIG. 11; and

FIG. 14 illustrates schematically one example of a visual display generated by the computer of FIG. 11.

### DETAILED DESCRIPTION OF A SPECIFIC MODE FOR CARRYING OUT THE INVENTION

There will now be described by way of example a specific mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

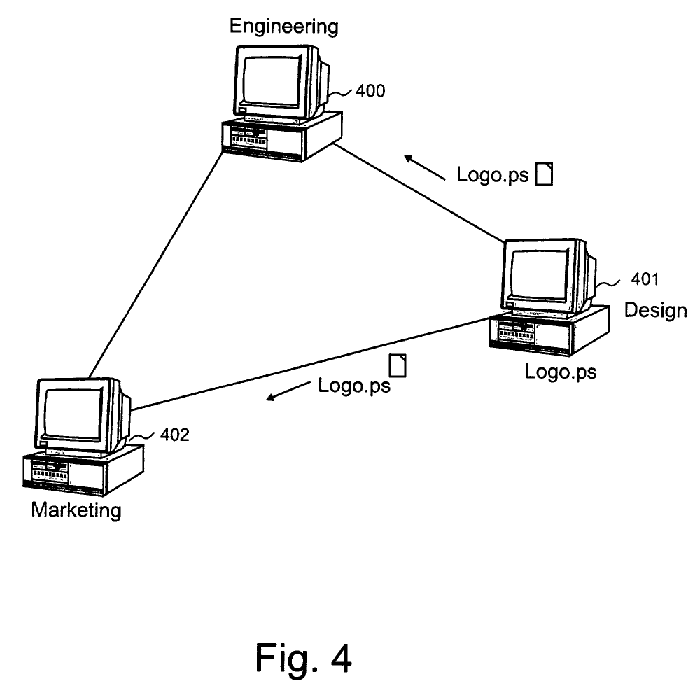

Referring to FIG. 4 herein, there is illustrated schematically a network of computers connected as a Gnutella network. Such a network may be used for example in a small company, and where workers may work outside a central location, for example working from home. In the example of FIG. 4, the network comprises three computers, for example personal computers 400-402, situated in an engineering department, a design department, and a marketing department respectively. The three computers, the design computer, engineering computer and marketing computer may be located at different locations and do not share a local network. The computers may be connected via a wide area network or a virtual network. File sharing between computers may occur according to the known Gnutella protocol.

For a file which is regularly used, and regularly updated, for example a file containing a company logo logo.ps, frequent requests for the file may be made over the network. For example, where a worker in the marketing department is preparing literature, the worker needs to make sure that the most up to date version of the company logo is used in the literature being prepared upon marketing computer 402. The An issue is to make sure that every time the logo image is updated, in the logo.ps file, the correct version of the file is used by the engineering computer 400 and the marketing computer 402, and the correct data file is propagated to those computers.

This can be achieved in a peer to peer Gnutella network of arbitrary topology, by creating a new type of message which applies constraints. In the context of a network in which host computers and files to be shared are known, a file sharing system can be defined by use of constraints representing the operations of downloading individual file items from one host computer to another, and the operation of file downloading may be automated. By analyzing properties of the constraints, it can be ensured that projected automated downloads of files are performed correctly, without file request messages propagating around any loops within a network of peer to peer connected computers.

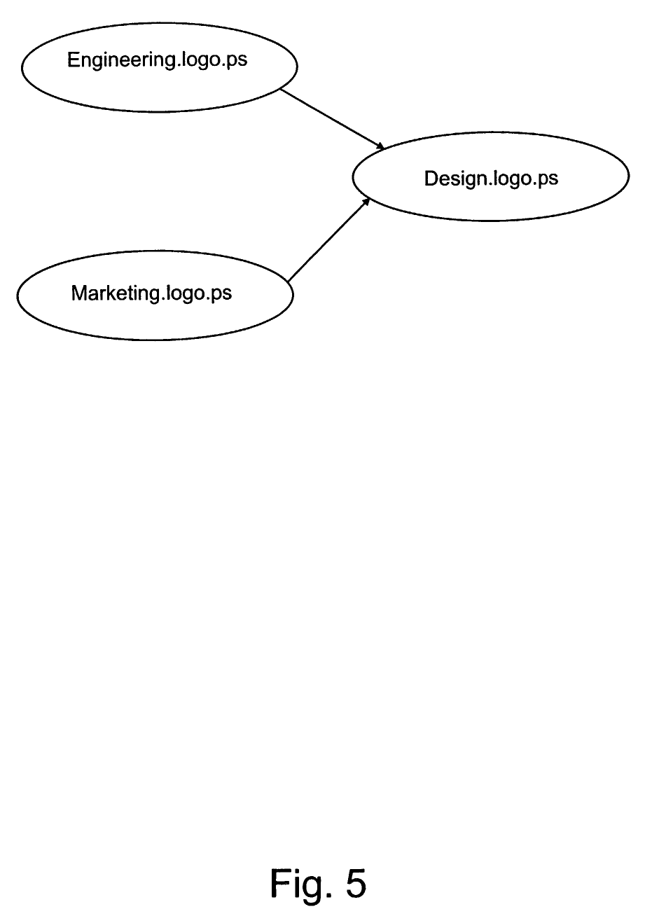

Referring to FIG. 5 herein, an intelligent file sharing mechanism is implemented in the network of FIG. 4 by use of constraints. The constraints are represented logically between files engineering.logo.ps, design.logo.ps and marketing.logo.ps.

Two directional constraints are applied, firstly between the engineering computer and the design computer, and secondly between the marketing computer and the design computer. Expressions of the constraints may be stated as follows:

engineering.logo.ps==design.logo.ps

marketing.logo.ps==design.logo.ps

This means that the file logo.ps stored at the engineering computer 400 is maintained to be a copy of the logo.ps file stored at the design computer 401, and that the logo.ps file stored at the marketing computer 402 is also maintained to be the same as the logo.ps file stored at the design computer 400.

The network can now keep an automatic update of data at the engineering and marketing computers, which reflects the current file version logo.ps stored at the design computer.

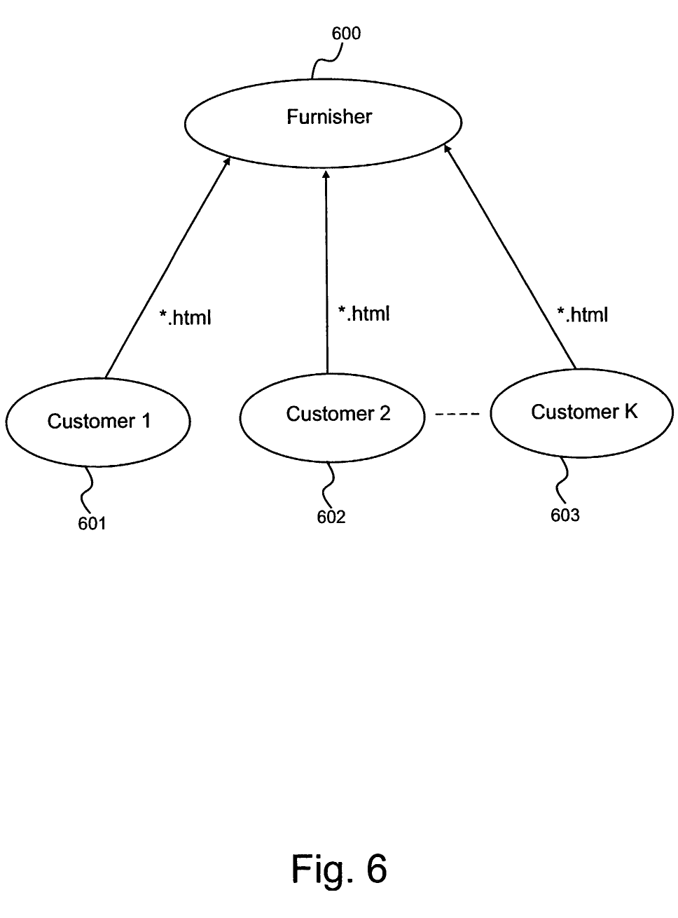

Referring to FIG. 6 herein, there is illustrated schematically a logical view of a second example of a constrained peer to peer network. A furnishing company 600 has one or a plurality of computers, connected in a Gnutella network, with at least one computer at each of a plurality of customers 601-603. The furnishing company stores a catalogue of products as a file on one of its computers. Each customer computer may access the file over the network. The catalogue file perpetually evolves, with constant changes to price, specification, product range and delivery time. By applying file sharing constraints between each of the customer computers and the furnishing company computer such that any changes to the catalogue file at the furnishing company computer are copies to the customer computers, it can be ensured that each customer has access to a constantly updated catalogue file.

By applying constraints in a Gnutella network, there can be achieved the feature of a client-server architecture, in which each client computer knows the location of a particular file on a server computer, but also the flexibility of a peer to peer network, enabling other computers to co-operate with any individual host computer on a peer to peer basis.

There will now be described a constraint model for controlling computers in a peer to peer network.

The constraint model below can be easily converted into a constraint programming model as will be appreciated by those skilled in the art resulting in a set of program instructions for programming a general purpose computer, or alternatively for producing a hard wired application specific integrated circuit (ASIC) to implement the constraint functionality.

A set of constraints are defined as follows:

X={X1, X2, . . . , Xn}, represents the set of variables is represented by the hosts in the network.

D={D1, D2, . . . , Dn}, represents the domains of each variable. Each Di is a finite set of values represented by the files available for sharing.

C={C1, C2, . . . , Ck}, represents the constraints between host computers.

A variable X may be for example a computer within a particular department of a firm, for example a design department computer, and practically may be implemented with knowledge of a unique identification of that computer, for example an Ethernet address of that computer.

The domain D of a variable comprises a list of files in a hard drive of a variable. That is, a list of files on a hard disk drive of a computer.

Constraints C are binary, that is between first and second individual computers, and are defined by a user of the computer.

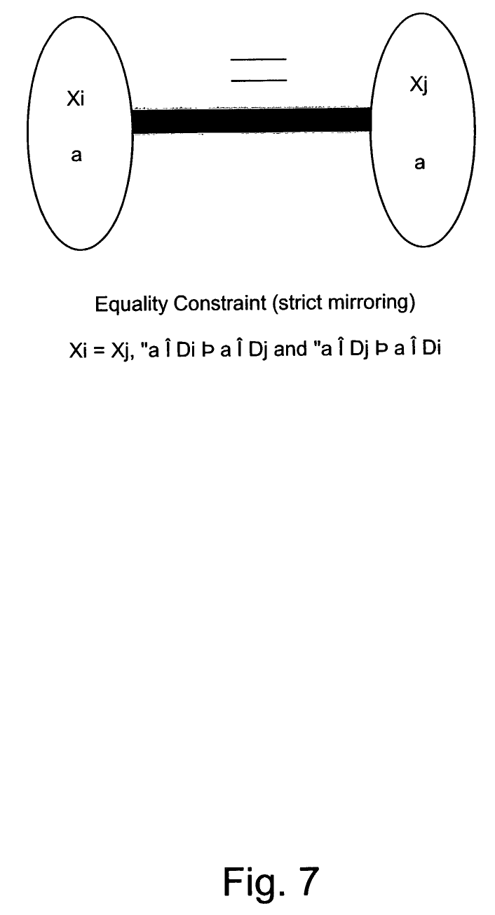

Three classes of constraint are defined as shown in FIGS. 7 to 9 herein.

Referring to FIG. 7 herein, there is illustrated a class of equality constraints. An example of an equality constraint is Xi=Xj. This means that the content of a file a on first computer Xi is the same as the content of a file a on second computer Xj. The reverse is also true, the content of file a on computer Xj is the same as the content of the file a on computer Xi. Di is the domain of computer Xi. For all instances of individual file a in the domain Di, the equality constraint applies to make a corresponding respective identical file in the domain Dj on computer Xj. Similarly, for all instances of a file a in domain Dj on computer Xj, there is a corresponding respective identical file a in domain Di on computer Xi.

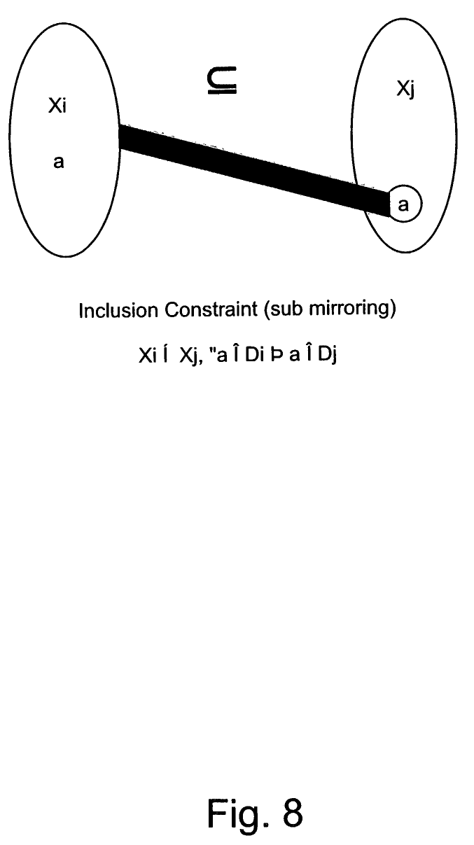

Referring to FIG. 8 herein, there is illustrated schematically a class of inclusion constraints. In this case, in a first computer Xi having domain Di, every time there is a file a, that file is copied to a domain Dj in second computer Xj. This constraint may be applied in the example of FIG. 5 herein before described, where every time the file design.logo.ps is changed, it is copied into the engineering computer 400 and marketing computer 402 in their respective domains (file systems).

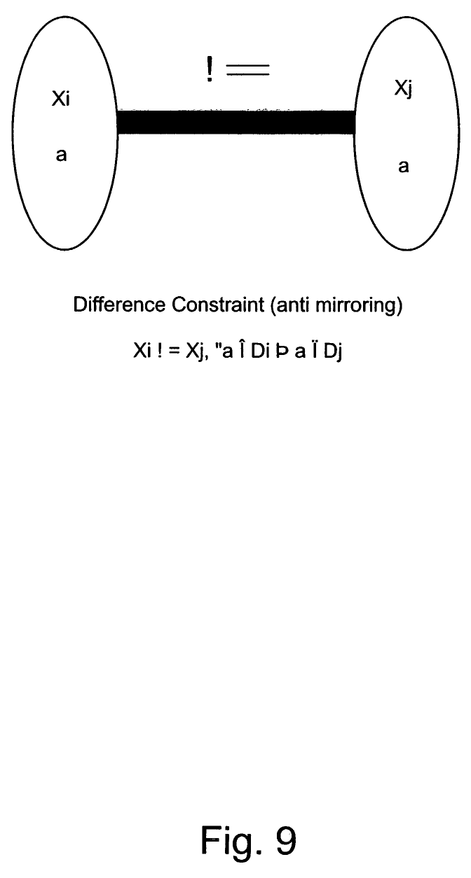

Referring to FIG. 9 herein, there is illustrated schematically a class of difference constraints. A difference constraint can be used to prevent the same file appearing on two different specified computers, bound by the constraint. A difference constraint is written as Xi \overline{T}=Xj. For each file a in domain Di, a corresponding respective file a is constrained to not exist on second domain Dj of second computer Xj.

By applying the above constraints in a peer to peer network, lends a property to a network that it is not necessary to search for a file every time a file is requested by a computer in the network, as would otherwise occur in the Gnutella protocol. Using the constraints, individual pairs of computers within a network are tied, so that their domains (file systems) may be linked. Because there is a constraint linkage, it is not necessary to query a large number of computers in the network to find a particular file. An individual computer already “knows” the location of a file, because it is defined by a user specified constraint.

For other files which are not constrained, the peer to peer file search mechanism provided by the Gnutella protocol may operate independently of the constraints. The constraints only override the Gnutella protocol where they are specified for particular files, particular domains and particular computers. The constraints may therefore find application in known topologies of peer to peer connected computers, for example within a corporation, where other computers within the corporation are known, or within an extranet, for example where customers are included in the extranet, where the location and the topology of the extranet is known.

Provision of constraints may apply a hierarchical architecture to be imposed over a fundamentally peer to peer connected network of computers, as an overlay.

A notion of value must be specified. Values are defined as files of a shared directory. Defining equality between files of different file systems is not direct. File name and date must be considered. In Gnutella networks, specifying a date is problematic, since the Gnutella protocol does not support time synchronization. Therefore, a time synchronization feature between computers to which constraints apply must be defined.

Constraints are satisfied within the network by daemons, which are located on each constraint host as part of a new Gnutella client, and which can start an automatic download process. The goal of the daemons is to keep a consistent system, which is a Gnutella network, where the constraints are always satisfied. The interactions between daemons is related to the semantic of their shared constraints.

Strict Mirroring

The daemons inform each other for modifications of their domains (their file directories). They also inform each other of deletions. The latest version of each file is kept. This can be managed by negotiation. This means that while adding or modifying a file to its shared directory, a daemon, for example first computer Xi first gives the information to second computer Xj, then waits for an acknowledgement signal which starts an automatic download process. If the acknowledgement signal occurs, first computer Xi already knows that it will receive a new version for the file. Ties on date can be broken by initial end user interrogation or by static priority between hosts.

To stop file replications, downloads must be recorded with their initial global time stamp.

Sub Mirroring

Sub mirroring operates similarly to strict mirroring, except that one host computer, Xi, keeps the other host computer informed of modifications. First host computer Xi can automatically start an upload to second host computer Xj. Two behaviors can be adopted. In this case, the date data is not important, since files from first computer Xi are duplicated on second computer Xj. Any update of the files on Xj are not reported to first computer Xi.

Anti Mirroring

This is the inverse of strict mirroring for the daemons.

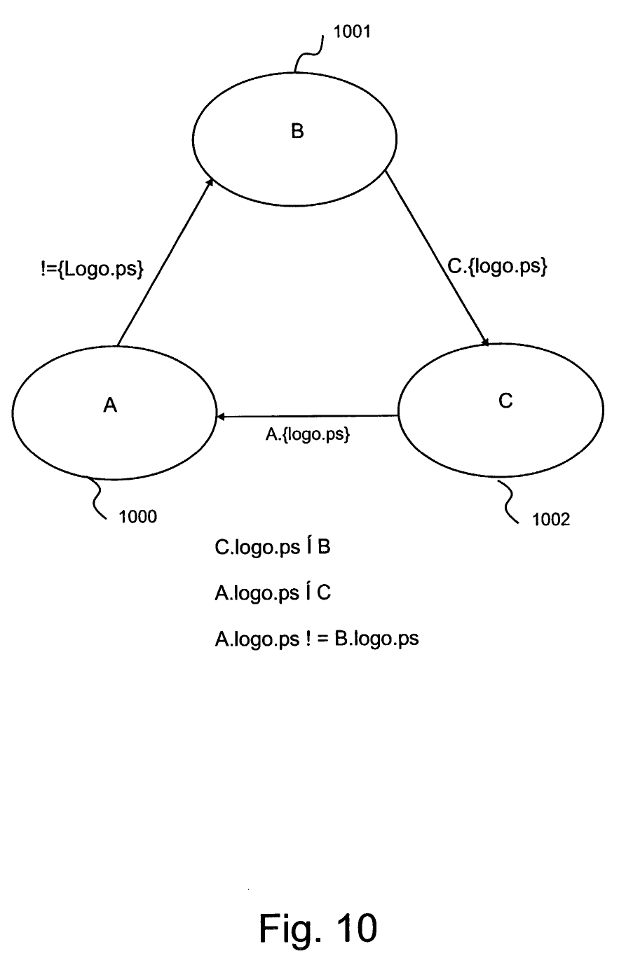

Referring to FIG. 10 herein, there is illustrated an example of conflicting constraints between three computers A, B, C, 1000-1002 respectively. In this case, monotonic constraints apply simultaneously on the same object, in this case the file logo.ps. A constraint between first and second computers 1000, 1001 is a difference constraint, such that file logo.ps cannot reside on both computer A and computer B. A constraint set up between computers B and C is that the file logo.ps resident on computer C is included on computer B. An inclusion constraint between computers A and C is that a file logo.ps on computer A is automatically copied and included onto computer C. However, because of the difference constraint between computers A and B, automatically copying logo.ps to computers B and A is disallowed. Therefore at least one constraint must be violated in a scene where the file logo.ps is modified in A then uploaded to C, then to B, then A gets informed by B of the appearance of a modified file logo.ps, and deletes it according to the difference constraint, then any changes to file logo.ps on computer A will be defeated.

In this example, there is a circuit of constraints in the network involving a difference constraint and the corresponding problem has no solution. In the context of the network, this means that a single modification to a file cannot be accurately reported by the daemons. In the worst case, the computers enter an endless loop of action, which is to be avoided.

One solution to the approach to constricting constraints is to exclude any anti mirroring constraints. This causes the daemons to co-operate with strict mirroring and sub mirroring which is monotonic, that is, two constraints allow stabilization of the operations in the network. This method applies to a network of any topology. A main advantage of this approach is that constraints can be posted independently in the network. The resulting independence is adequate with the distributed nature of Gnutella networks.

If anti mirroring constraints are allowed, then stabilization of operations between daemons must be ensured. This is equivalent to the decision problem in “is there a solution for the constraint network”. This problem is difficult to solve, i.e. NP-complete. The problem requires pre-processing before applying any automatic downloading features. In this scenario, users must decide by an off line simulation whether their automatic file sharing system is feasible.

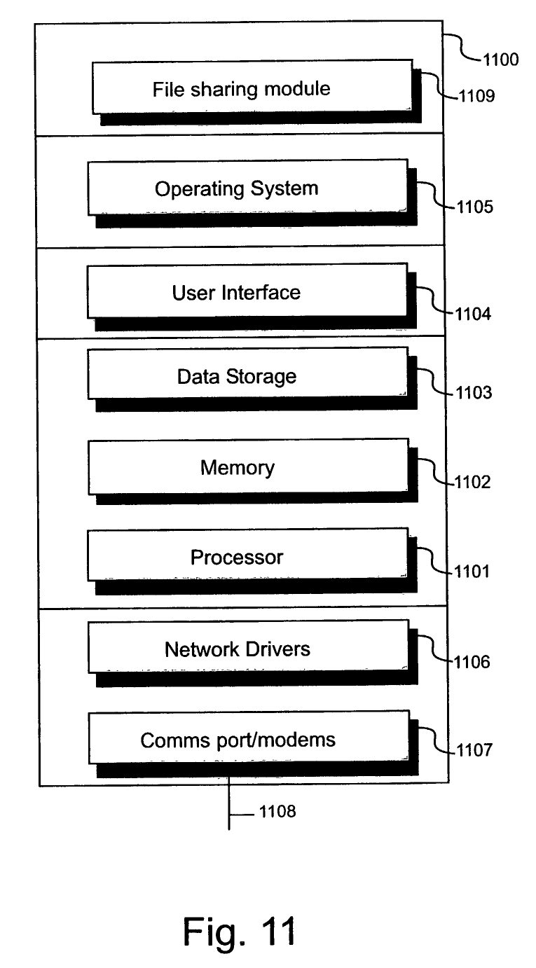

Referring to FIG. 11 herein, there is illustrated schematically a specific embodiment of a computer entity configured for operating within a network environment amongst a plurality of other computers, in which constraint based connectivity as described herein above may be applied. The computer comprises a known computer entity, for example a personal computer or the like having a processor 1101, memory 1102, known data storage device 1103, for example a hard disk drive; user interface 1104 including video display device, keyboard and pointing device for example a mouse; a known operating system 1105, for example a Windows 2000, Windows NT, Unix or Linux operating system; one or more network drivers 1106; one or more communications ports and modems 1107 for communicating with other computer entities over a network connection 1108, for example a local area network (LAN) or wide area network (WAN); and a file sharing module 1109 for enabling a user to create constraints and relationships with other computers, for file sharing.

The file sharing module 1109 comprises a set of user definable messages constructed according to the constraint types as described herein before.

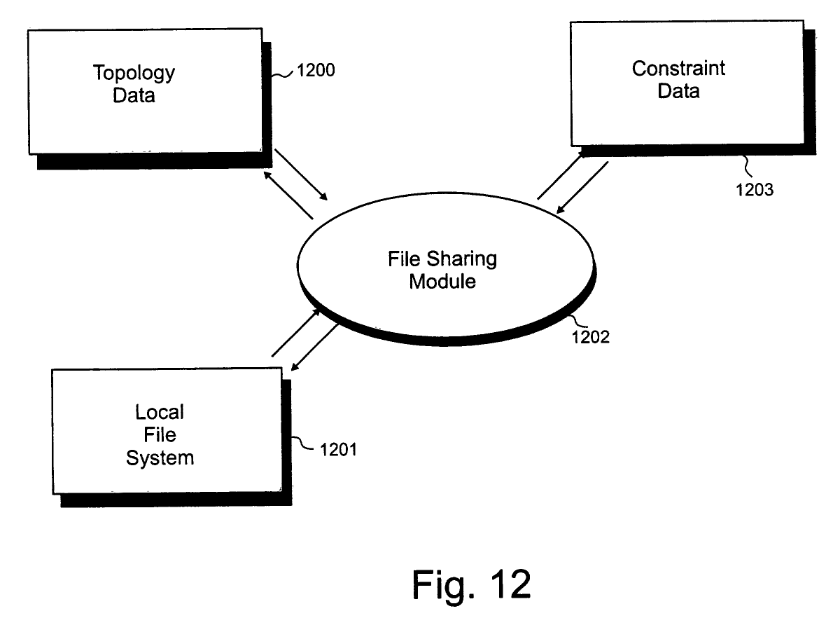

Referring to FIG. 12 herein, there is illustrated schematically logical components of the computer of FIG. 11. Topology data describing the topology of the network, of which the computer is locally connected, is stored in a topology database 1200. A local file system 1201 of the computer is accessible by file sharing module 1202, in order for a user to build defined constraints. Constraint data representing a set of constraints already constructed by a user is stored in a constraint database 1203.

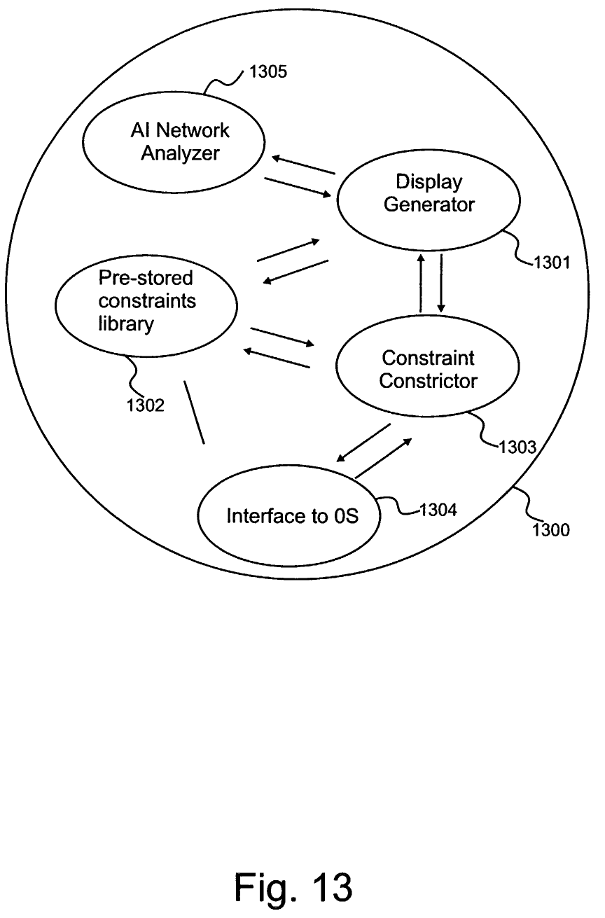

Referring to FIG. 13 herein, file sharing module 1300 comprises a display generator 1301, for generating a visual display on the user interface of the computer; a pre-stored constraints library 1202, storing syntax defining a plurality of pre-set constraint types, which are user configurable; a constraint constructor 1303 for constructing constraints, as input by a user using a display generatory by display generator 1301 and constraints syntax stored in the pre-stored constraints library 1302; and an interface 1304 to an operating system of the computer, through which constraints are applied in the network.

There is optionally also provided a network analyzer 1305, for analyzing if a proposed constraints or set of constraints can be implemented in the wider network. The network analyzer draws data from the topology database 1200, local file system database 1201 and constraint database 1203, to input information describing constraints already applying to the host computer. Additionally, the network analyzer requires information concerning existing constraints of any other computer in a network to which a new constraint is proposed to be implemented, and can request this information from other user specified computers on the network. The network analyzer may be implemented by a variety of known artificial intelligence technologies, for example a neural network engine, a genetic algorithm, or an huristic algorithm as is known in the art of network analysis. The function of the network analyzer is to check for conflicting constraints, when a user attempts to apply a new constraint via display generator 1201.

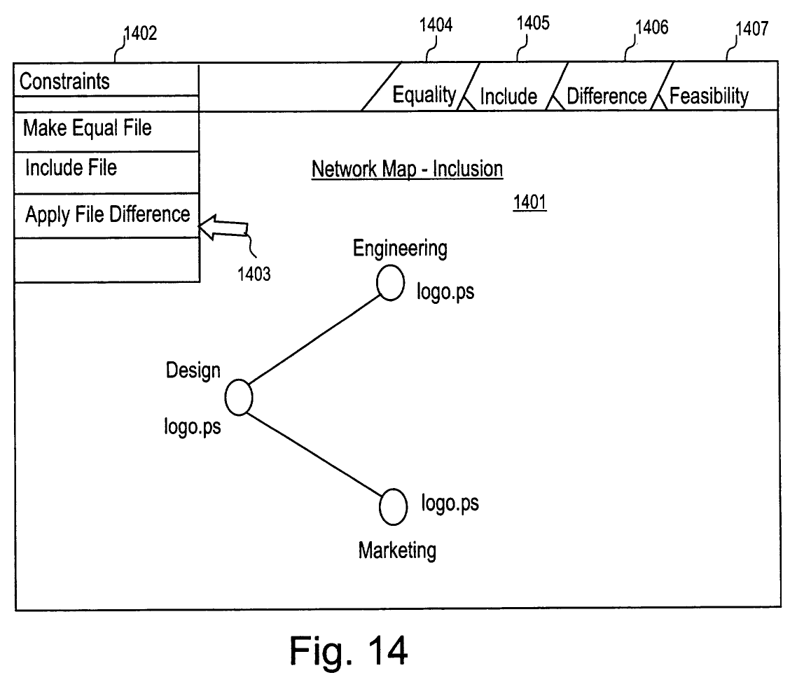

Referring to FIG. 14 herein, there is illustrated schematically a visual display generated by display generator 1301, by means of which a user may define constraints between individual files on computers in a known network. Such a visual display may comprise a two dimensional node-link representation of a network, displaying lists of constraints which apply between individually selected nodes within the network. A node and link representation 1400 is displayed with a display 1401 window, showing each computer in the network as a node, and showing a plurality of links between nodes. A drop down menu 1402 provides a user selectable menu for creation of new constraints. Activation of the menu, in conjunction with selection of a pair of nodes by positioning pointer icon 1403 over first and second node icons, results in creation of a constraint between selected nodes.

Within display window 1401, separate views may be included, giving a view of equality constraints, a view of inclusion constraints and a view of difference constraints, selectable by activating a tab icon 1404-1406 as shown.

A network feasibility tab 1407 may be activated to access network analyzer 1205, to asses the feasibility of any proposed constraints which are entered by the user within the display window 1401. Feasibility tab is used to access the network analyzer tool 1405, by which the user can perform a network analysis of a proposed network including newly entered constraints, prior to actually implementing those constraints in the host computer.

In the view shown, inclusion constraints are shown between a file logo.ps, between a design computer and an engineering computer, and between the design computer and a marketing computer, such that the engineering and marketing computers include a copy of the logo.ps file stored on the design computer.

In a network where each computer has the capability of setting constraints with peer computers, there arises the issue of inconsistencies between conflicting constraints.

1. A method for constraining file systems of computers within a network comprising a plurality of peer to peer connected computers, said method comprising:
selecting first and second computers of said plurality of computers;
applying at least one constraint between respective file systems of said first and second computers.

2. The method as claimed in claim 1, wherein a said constraint comprises:
an equality constraint, in which a selected file on said first computer is constrained to be maintained in a file system of said second computer.

3. The method of claim 1, wherein said constraint comprises:
a difference constraint, wherein a file resident on a file system of a first said computer is prohibited from occurring in a file system of a second said computer.

4. The method as claimed in claim 1, wherein a said constraint comprises:
an inclusion constraint, wherein a file resident in a first file system of said first computer is constrained to be included within a second file system of a second said computer.

5. The method as claimed in claim 1, comprising:
said first computer, informing said second computer of a deletion of a specified file.

6. The method as claimed in claim 1, wherein:
a said first computer informs a second said computer of a deletion of a specified file from a file system of said first computer;
said second computer sends an acknowledgement signal to said first computer acknowledging said message; and comprising the process of:
performing an automatic download process between said first and second computers.

7. The method as claimed in claim 1, wherein:
a said first computer informs a second said computer of a deletion of a specified file from a file system of said first computer;
said second computer sends an acknowledgement signal to said first computer acknowledging said message; and comprising the process of:
completing within a predetermined time an automatic download process between said first and second computers.
wherein said download process is completed within a pre-determined time.

8. The method as claimed in claim 1, comprising:
a first said computer entity automatically informing a second said computer entity of file modifications occurring in a first file system to a said first computer.

9. A computer entity comprising:
at least one data processor;
at least one memory device;
at least one data storage device;
a topology database storing topology data describing a set of constraints applied in a peer to peer network;
a file system, for storing data files within said data storage device; and
a constraint database storing data describing a set of constraints applied to said computer entity between said computer entity and at least one other computer entity.

10. The computer entity as claimed in claim 9, comprising:
a display generator capable of displaying a graphical representation of a connectivity of said computer, wherein said graphical representation comprises a view of at least one constraint applied to said computer.

11. The computer entity as claimed in claim 9, comprising:
a constraint construction component, for enabling a user to construct at least one constraint between said computer and at least one other said computer; and
a constraint library storing a set of pre-stored constraint types, which can be applied between said computer and at least one other selected computer.

12. The computer entity as claimed in claim 9, comprising:
a network analyzer component capable of identifying conflicting constraints applied to said computer entity.

13. The computer entity as claimed in claim 9, comprising:
a topology database storing topology data describing a topology of a network of peer to peer connected computers;
a constraint database storing data describing a set of constraints applied between said computer entity and at least one other computer entity of said network;
a file system for storing data files to which at least one said constraint may be applied.

14. A method for connecting file systems of computers within a network comprising a plurality of peer to peer connected computers, said method comprising:
selecting first and second computers of said plurality of computers;
applying a difference constraint between respective file systems of said first and second computers, wherein a file resident on said file system of said first computer is prohibited from occurring in said file system of said second computer.

15. A computer entity comprising:
at least one data processor;
at least one memory device;
at least one data storage device;
a file system, for storing data files within said data storage device;
a constraint database storing data describing a set of constraints applied to said computer entity; and
a network analyser component capable of identifying conflicting constraints applied to said computer entity.

16. Program data comprising instructions for causing a computer entity to:
store data describing a set of constraints applied to said computer entity; and
identify conflicting constraints applied to said computer entity.

17. A data storage medium carrying program data comprising instructions for causing a computer entity to:
store data describing a set of constraints applied to said computer entity; and
identify conflicting constraints applied to said computer entity.

18. Program data comprising instructions for causing a computer entity to perform a method of connecting file systems of computers within a network comprising a plurality of peer to peer connected computers, said method comprising;
applying a difference constraint between respective file systems of said computer entity and a further said computer entity, wherein a file resident on a file system of said computer is prohibited from occurring in a file system of said further computer.

19. A data storage medium carrying program data comprising instructions for causing a computer entity to perform a method of connecting file systems of computers within a network comprising a plurality of peer to peer connected computers, said method comprising;
applying a difference constraint between respective file systems of said computer entity and a further said computer entity, wherein a file resident on a file system of said first computer is prohibited from occurring in a file system of said further computer.

20. A method of connecting a file system of a computer entity, said method comprising;
applying at least one constraint to said file system, said constraint specifying a restriction on co-operation of said file system with a file system of at least one other peer computer entity.

21. The method as claimed in claim 20, wherein a said constraint comprises:
an equality constraint, in which a selected file on said computer entity is constrained to be maintained in a file system in said at least one other computer entity.

22. The method as claimed in claim 20, wherein a said constraint comprises:
a difference constraint, wherein a file resident on a file system of said computer entity is prohibited from occurring in a file system of at least one other computer entity.

23. The method as claimed in claim 20, wherein a said constraint comprises:
an inclusion constraint, wherein a file resident in said file system of said computer entity is constrained to be included within a file system of at least one other computer entity.
